(19) United States
(12) Patent Application Publication
(10) Pub. No.: US 2026/0098323 A1
(43) Pub. Date: Apr. 9, 2026

(54) RECOVERING URANIUM FROM A URANYL NITRATE SOLUTION

(71) Applicant: X-ENERGY, LLC, Rockville, MD (US)

(72) Inventors: Alex Tilton, Knoxville, TN (US); Nicholas Linneen, Knoxville, TN (US)

(21) Appl. No.: 19/415,153

(22) Filed: Dec. 10, 2025

Related U.S. Application Data
(62) Division of application No. 17/876,517, filed on Jul. 28, 2022.

(51) Int. Cl. C22B 60/02; C22B 3/14; C22B 3/22; C22B 3/44

(52) U.S. Cl. CPC C22B 60/0247; C22B 3/14; C22B 3/22; C22B 3/44; C22B 60/0278; C22B 60/0286

(57) ABSTRACT

A useful metal may be recovered from a solution of a nitrate salt of a metal cation or a metal oxycation, by adding the solution of the nitrate salt to a formation column having an inlet and an outlet nozzle, the solution of the nitrate salt being added in a dropwise fashion through the inlet. The formation column contains a recirculating solution containing a base selected from the group consisting of ammonia, ammonium hydroxide, an alkali metal hydroxide, and an alkaline earth metal hydroxide. The nitrate salt reacts with the base in the recirculating solution to produce a metal oxide salt or a metal hydroxide salt as a precipitate. The precipitate and the recirculating solution exit the formation column through the outlet nozzle and are captured the precipitate in a basket beneath the formation column while recovering the recirculating solution in a catch tank under the basket. The recovered recirculating solution is pumped from the catch tank to the formation column. The nitrate salt of the metal cation may be a nitrate salt of a radioactive metal cation, e.g., uranium or a uranyl cation.

### CROSS-REFERENCE TO RELATED APPLICATIONS

The present application is a divisional patent application claiming priority to U.S. patent application Ser. No. 17/876,517, filed on Jul. 28, 2022. The entire disclosure of the prior application is incorporated herein by reference.

### TECHNICAL FIELD

Various exemplary embodiments disclosed herein relate generally to recovery of radioactive metals, e.g., uranium, as ceramics from a raw material for forming uranium oxide gel particles, e.g., uranyl nitrate.

### BACKGROUND

Metal nitrates are useful precursors for metal oxides prepared by a sol-gel process, where the metals may be main group metals, e.g., lead, transition metal, e.g., yttrium. iron or zirconium, or lanthanide metals.

For example, iron oxides have been prepared by heating the product of a sol-gel reaction between iron (III) nitrate and ethylene glycol. Depending on conditions, maghemite and/or hematite may be produced from iron (III) nitrate. Lead zirconate titanate (PZT) powders may be prepared by a sol-gel method, using lead nitrate, zirconium nitrate, and tetrabutyl titanate as precursors. Yttrium oxide may be prepared by a sol-gel process using yttrium nitrate as a precursor.

Nitrate salt precursors may also be used to prepare oxides of radioactive metals. Uranyl nitrate is a water-soluble uranium compound useful for manufacture of uranium oxide kernels for applications in nuclear fuel. Oxides of plutonium and thorium also have applications in nuclear energy and may be prepared by a sol-gel process from corresponding nitrate salts. Radioactive metal oxide gel particles may be prepared using a uranyl nitrate solution containing hexamethyltetramine (HMTA) and urea. Metal ion-urea complexes of formula UO₂((NH₂)₂CO)₂⁺² form initially, where the urea may help mitigate premature gelation. The solution is then heated to a temperature sufficient to induce HMTA decomposition. When the metal ion-urea complexes are heated, they may dissociate to form UO₂⁺² or similar uranium oxide species. Metal ions hydrolyze and condense as in reactions (1) and (2):

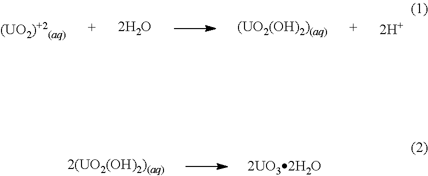

Simultaneously, HMTA decomposes to form ammonium hydroxide. The ammonium hydroxide increases the pH of the solution, promoting hydrolysis and condensation and resulting in formation of the metal ion particulates 2UO₃·2H₂O as spherical gel particles. The uranium oxide gel spheres are collected and sintered to form ceramic particles useful as kernels for nuclear fuel pellets.

Uranyl nitrate waste is regulated as hazardous radioactive waste. Consequently, waste or scrap uranyl nitrate is not easily disposed of. Radioactive uranium can be recovered from uranyl nitrate solutions by using a base to generate insoluble uranates. For example, reaction of uranyl nitrate with ammonia or ammonium hydroxide produces ammonium diuranate.

Handling an ammonium diuranate (ADU) precipitate presents material handling challenges due to the viscid properties of the solid. Transferring raw ADU between vessels leaves a substantial amount of material behind and results in difficult cleanout operations and loss of material to waste.

### SUMMARY

In light of the present need for improved methods of recovering uranium from scrap uranyl nitrate solutions, a brief summary of various embodiments is presented. Some simplifications and omissions may be made in the following summary, which is intended to highlight and introduce some aspects of the subject matter disclosed herein, but not to limit the scope of the invention. Detailed descriptions of certain embodiments adequate to allow those of ordinary skill in the art to make and use the inventive concepts will follow in later sections.

When conducting a sol-gel reaction using a metal nitrate to produce a metal oxide, it is common that unreacted nitrate salts remain in a supernatant after producing an oxide gel. Such unreacted metal nitrate salts cannot be readily disposed of, particularly in cases involving nitrate salts of heavy metals and/or radioactive metals. These nitrate salts are environmental pollutants and may be toxic to humans and animals exposed to them. The present disclosure is directed to methods of recovering and reusing metals from a waste metal nitrate solution.

Various embodiments disclosed herein relate to recovery of uranium from a uranyl nitrate solution, although the disclosed processes are not limited to uranium in particular, or radioactive metals in general. The disclosed process may be generalized to recovery of metals from solutions of nitrate salts of metal cations or metal oxycations.

One general aspect disclosed herein includes a method of recovering a useful metal from a solution of a nitrate salt of a metal cation or a metal oxycation. The method includes steps of adding the solution of the nitrate salt to a formation column having an inlet and an outlet nozzle, the solution of the nitrate salt being added in a dropwise fashion through the inlet, where the formation column contains a recirculating solution containing a base selected from the group may include ammonia, ammonium hydroxide, an alkali metal hydroxide, and an alkaline earth metal hydroxide. The method also includes allowing the nitrate salt in the solution to react with the base in the recirculating solution to produce a metal oxide salt or a metal hydroxide salt as a precipitate; allowing the precipitate and the recirculating solution to exit the formation column through the outlet nozzle, capturing the precipitate in a basket beneath the formation column while recovering the recirculating solution in a catch tank under the basket, and pumping the recovered recirculating solution from the catch tank to the formation column.

Implementations may include one or more of the following features. In various embodiments, the nitrate salt is a salt of a cation or an oxycation of:
a transition metal, e.g., iron, zirconium, or titanium;
a lanthanide metal, e.g., cerium; or
an actinide metal, e.g., uranium, thorium, or plutonium.

In various embodiments disclosed herein, the nitrate salt is uranyl nitrate, thorium nitrate, or plutonium nitrate. In cases where the nitrate salt is uranyl nitrate, the base may be ammonia or ammonium hydroxide, and the precipitate is ammonium diuranate.

In various embodiments, the precipitate is kept in the basket during the washing and drying steps. The method may include:
transporting the basket containing the captured precipitate from beneath the formation column into an oxidizing furnace; and
heating the basket containing the captured precipitate in the oxidizing furnace to convert the precipitate into a metal oxide.

One general aspect includes a system for recovering a useful metal from a solution of a nitrate salt of a metal cation or a metal oxycation. The system also includes:
a formation column having an inlet and an outlet nozzle, where the inlet is configured to admit the nitrate salt solution to the formation column in a dropwise fashion;
a basket under the outlet nozzle;
a catch tank under the basket; and
a recirculation system which may include a first pump and a flow path between the catch tank and the formation column, where:
   the first pump is configured to pump a recirculating solution containing a base from the catch tank to the formation column; and
   the catch tank is configured to receive the recirculating solution from the formation column.
      In various embodiments, the formation column is configured to allow the base in the recirculating solution to react with the nitrate solution to produce a metal oxide salt as a precipitate, and the outlet nozzle is configured to allow the recirculating solution and the precipitate to exit the formation column. The basket is configured to capture the precipitate while allowing the recirculating solution to flow into the catch tank.

Various embodiments relate to methods of recovering uranium from a uranyl nitrate solution, by adding the uranyl nitrate solution to a formation column having an inlet and an outlet nozzle, where the uranyl nitrate solution is added in a dropwise fashion through the inlet. The formation column contains a recirculating solution containing a base, which may be ammonia, ammonium hydroxide, an alkali metal hydroxide, or an alkaline earth metal hydroxide. The uranyl nitrate solution is allowed to react with the base in the recirculating solution to produce a diuranate salt as a precipitate. The precipitate and the recirculating solution exit the formation column through the outlet nozzle, and the precipitate is captured in a basket beneath the formation column while recovering the recirculating solution in a catch tank under the basket. The recovered recirculating solution is then pumped from the catch tank to the formation column.

In various embodiments, the base is ammonia or ammonium hydroxide, and the precipitate is ammonium diuranate. The base may be ammonium hydroxide.

The base may be an alkali metal hydroxide, and the precipitate may be an alkali metal diuranate.

The method may include additional steps of washing the diuranate salt precipitate with an aqueous wash solution; and drying the washed precipitate. The precipitate may be retained in the basket during the washing and drying steps.

The method may include steps of transporting the basket containing the captured precipitate from beneath the formation column into an oxidizing furnace. The basket containing the captured precipitate may then be heated in the oxidizing furnace to convert the precipitate into a uranium oxide. The uranium oxide may be UO₂, U₂O₅, UO₃, U₃O₈, UO₂O₂, or a mixture thereof.

Various embodiments disclosed herein relate to a system for recovering uranium from a uranyl nitrate solution. The system includes:
a formation column having an inlet and an outlet nozzle, wherein the inlet is configured to admit the uranyl nitrate solution to the formation column in a dropwise fashion;
a basket under the outlet nozzle;
a catch tank under the basket; and
a recirculation system comprising a first pump and a flow path between the catch tank and the formation column.

The first pump is configured to pump a recirculating solution containing a base from the catch tank to the formation column, and the catch tank is configured to receive the recirculating solution from the formation column. The formation column is configured to allow the base in the recirculating solution to react with the uranyl nitrate solution to produce a diuranate salt as a precipitate. The outlet nozzle is configured to allow the recirculating solution and the precipitate to exit the formation column; and the basket is configured to capture the precipitate while allowing the recirculating solution to flow into the catch tank.

The system for recovering uranium from a uranyl nitrate solution may also include a wash station, a wash solution outlet, a wash tank below the wash solution outlet, a second pump; and a means for transporting the basket with the captured precipitate from under the outlet nozzle of the formation column to the wash station. In various embodiments, the second pump is configured to pump a wash solution from the wash tank to the wash solution outlet to produce a stream of wash solution; and the means for transporting is configured to position the basket under the wash solution outlet so that the captured precipitate is washed by the stream of wash solution.

The system for recovering uranium from a uranyl nitrate solution may also include an oxidizing furnace, and a means for transporting the basket with the washed precipitate from the wash station into the oxidizing furnace. The oxidizing furnace is configured to convert the precipitate into a uranium oxide.

As discussed above, the methods and devices disclosed herein are not limited to radioactive metals in general, or uranium in particular. Various embodiments relate to methods of recovering a metal from a metal nitrate solution, by adding the metal nitrate solution to a formation column having an inlet and an outlet nozzle, where the metal nitrate solution is added in a dropwise fashion through the inlet. The formation column contains a recirculating solution containing a base, which may be ammonia, ammonium hydroxide, an alkali metal hydroxide, or an alkaline earth metal hydroxide. The metal nitrate solution is allowed to react with the base in the recirculating solution to produce a metal oxide salt or a metal hydroxide salt as a precipitate. The precipitate and the recirculating solution exit the formation column through the outlet nozzle, and the precipitate is captured in a basket beneath the formation column while recovering the recirculating solution in a catch tank under the basket. The recovered recirculating solution is then pumped from the catch tank to the formation column. In various embodiments, the nitrate salt is a transition metal nitrate salt, such as iron (III) nitrate or yttrium (III) nitrate. When using iron (III) nitrate as a precursor, the base in the recirculating solution is ammonium hydroxide, and the precipitate is iron (III) hydroxide. Iron (III) hydroxide is converted to an iron oxide in a furnace.

In various embodiments, the nitrate salt is a lanthanide metal nitrate salt, such as cerium (III) nitrate. When using cerium (III) nitrate as a precursor, the base in the recirculating solution is ammonium hydroxide, and the precipitate is cerium (III) hydroxide. Cerium (III) hydroxide is converted to an yttrium oxide in a furnace.

### BRIEF DESCRIPTION OF THE DRAWINGS

In order to better understand various exemplary embodiments, reference is made to the accompanying drawings, wherein:

FIG. 1 illustrates a system for recovering uranium from scrap uranyl nitrate solution, including a formation column for precipitation of a diuranate salt;

FIG. 2 illustrates a basket for capturing the precipitated diuranate salt; and

FIG. 3 illustrates a system for recovering a diuranate salt from scrap uranyl nitrate solution, and oxidizing the diuranate salt to a uranium oxide.

### DETAILED DESCRIPTION

In the present disclosure, precipitation of a metal oxide salt will be understood to encompass precipitation of a metal oxide salt, a metal hydroxide salt, a mixture thereof, or a metal oxide salt with a hydroxide ligand(s).

The system and method disclosed herein is useful for recovering metal values from solutions of metal nitrates used as precursors in synthesis of metal oxides. When unreacted metal nitrates are left over from synthesis of the desired oxide, it is economically undesirable to discard such nitrates. It is preferable to recover metal values from the nitrate solutions, and either directly convert the metals into a desirable product or recycle the metals for reuse.

Further, many oxides are made from toxic heavy metals or radioactive metals. When conducting a sol-gel reaction using a metal nitrate to produce a metal oxide, it is common that unreacted nitrate salts remain in a supernatant after producing an oxide gel. Such unreacted metal nitrate salts cannot be readily disposed of, particularly in cases involving nitrate salts of heavy metals and/or radioactive metals. These nitrate salts are environmental pollutants and may be toxic to humans and animals exposed to them. Even in cases where the metal itself, or where the metal nitrate salt itself, is not considered toxic, such metals or metal nitrates may undergo chemical changes once released into the environment which produce toxic compounds. Accordingly, waste solutions containing metal nitrates cannot be released into the environment. The present disclosure is directed to methods of recovering and reusing metals from a waste metal nitrate solution.

A method of recovering a useful metal from a solution of a nitrate salt of a metal cation or a metal oxycation may include steps of:
adding the solution of the nitrate salt to a formation column having an inlet and an outlet nozzle, the solution of the nitrate salt being added in a dropwise fashion through the inlet,
   wherein the formation column contains a recirculating solution containing a base selected from the group consisting of ammonia, ammonium hydroxide, an alkali metal hydroxide, and an alkaline earth metal hydroxide;
allowing the nitrate salt in the solution to react with the base in the recirculating solution to produce a metal oxide salt or a metal hydroxide salt as a precipitate;
allowing the precipitate and the recirculating solution to exit the formation column through the outlet nozzle;
capturing the precipitate in a basket beneath the formation column while recovering the recirculating solution in a catch tank under the basket; and
pumping the recovered recirculating solution from the catch tank to the formation column.

Referring now to the drawings, in which like numerals refer to like components or steps, there are disclosed broad aspects of various exemplary embodiments.

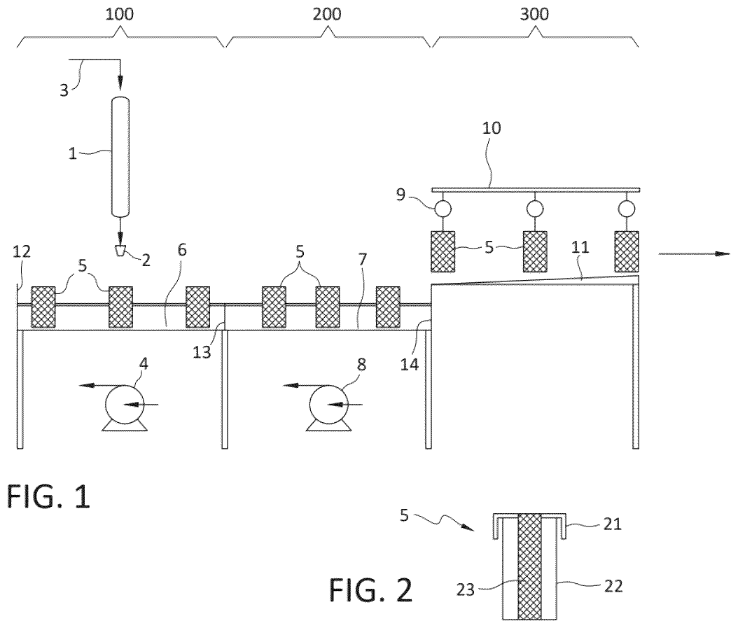

FIG. 1 shows a system for recovering useful metal from a solution of a nitrate salt of a metal cation or a metal oxycation. The system includes a recovery station 100. Recovery station 100 has a formation column 1 having an inlet 3 and an outlet nozzle 2. The inlet 3 carries a nitrate salt solution to the formation column 1, where the nitrate salt solution is added in a dropwise fashion to formation column 1 through the inlet 3. The formation column 1 contains a recirculating solution containing a base. The nitrate salt in the nitrate salt solution is allowed to react with the base in the recirculating solution to produce a oxide salt or a metal hydroxide salt as a precipitate. The precipitate and the recirculating solution exit the formation column through the outlet nozzle 2, and the precipitate is captured in a basket 5 beneath the formation column 1, while recovering the recirculating solution in a catch tank 6 under the basket 5. The recovered recirculating solution is then pumped from the catch tank 6 to the formation column 1 by pump 4.

In various embodiments, the formation column contains a recirculating solution containing ammonia, ammonium hydroxide, lithium hydroxide, sodium hydroxide, potassium hydroxide, calcium hydroxide, or magnesium hydroxide as a base.

The formation column may contain a recirculating solution containing ammonia or ammonium hydroxide as a base. The base reacts with the oxide salt or the metal hydroxide salt to precipitate an metal oxide salt or a metal hydroxide salt.

In various embodiments, the nitrate salt solution contains a nitrate salt of:
a cation or oxycation of a main group metal, e.g., a group 2 metal such as magnesium or calcium, a group 13 metal such as gallium or indium, a group 14 metal such as tin or lead, a group 15 metal such as bismuth, or a group 16 metal such as tellurium;
a cation or oxycation of a transition metal such as yttrium, zirconium, zinc, or iron,
a cation or oxycation of a lanthanide metal, e.g., cerium; or
a cation or oxycation of an actinide metal, e.g., thorium, uranium, or plutonium.

In various embodiments, the nitrate salt is iron (III) nitrate. The formation column contains a recirculating solution containing ammonium hydroxide as a base, and the base reacts with the iron (III) nitrate salt to precipitate an iron (III) hydroxide.

In various embodiments, the nitrate salt is yttrium (III) nitrate. The formation column contains a recirculating solution containing ammonium hydroxide as a base, and the base reacts with the yttrium (III) nitrate salt to precipitate an yttrium (III) hydroxide.

In various embodiments, the nitrate salt is a nitrate salt of a radioactive metal cation or oxycation, e.g., uranyl nitrate, thorium nitrate, or plutonium nitrate. The formation column may contain a recirculating solution containing an alkali metal hydroxide, an alkaline earth hydroxide, ammonium hydroxide salt, or ammonia as a base. The base reacts with the nitrate salt to precipitate a salt of the radioactive metal cation or oxycation.

In various embodiments, the nitrate salt is uranyl nitrate, and the formation column may contain a recirculating solution containing an ammonium hydroxide salt or ammonia as a base. The base reacts with the uranyl nitrate to precipitate an ammonium diuranate salt of formula (NH₄)₂U₂O₇.

In various embodiments, the nitrate salt is uranyl nitrate, and the formation column may contain a recirculating solution containing an alkali metal hydroxide M¹OH as a base. The base reacts with the uranyl nitrate to precipitate an alkali metal diuranate salt of formula M¹₂U₂O₇.

In various embodiments, the nitrate salt is uranyl nitrate, and the formation column may contain a recirculating solution containing an alkaline earth metal hydroxide M²(OH)₂ as a base. The base reacts with the uranyl nitrate to precipitate an alkaline earth metal diuranate salt of formula M²U₂O₇.

Further discussion will focus on recovery of uranium from a uranyl nitrate solution. In a system of FIG. 1 for recovering uranium, uranium is recovered from a solution of a nitrate salt of a metal cation or a metal oxycation. The system includes a recovery station 100. Recovery station 100 has a formation column 1 having an inlet 3 and an outlet nozzle 2. The inlet 3 carries a uranyl nitrate solution to the formation column 1, where the uranyl nitrate solution is added in a dropwise fashion to formation column 1 through the inlet 3. The formation column 1 contains a recirculating solution containing a base. The uranyl nitrate in the uranyl nitrate solution is allowed to react with the base in the recirculating solution to produce a diuranate salt as a precipitate. For example, if the base is ammonium hydroxide or ammonia, ammonium diuranate is obtained as a precipitate. The ammonium diuranate precipitate and the recirculating solution exit the formation column through the outlet nozzle 2, and the precipitate is captured in a basket 5 beneath the formation column 1, while recovering the recirculating solution in a catch tank 6 under the basket 5. The recovered recirculating solution is then pumped from the catch tank 6 to the formation column 1 by pump 4.

In embodiments where the nitrate salt is a nitrate salt of a radioactive metal cation or oxycation, it is advisable to prepare formation column 1 with an outer diameter of 4.5 inches or less, 4 inches or less, 3 inches or less, or 2 to 4.5 inches to avoid criticality events. In embodiments where the nitrate salt is a nitrate salt of a non-radioactive metal cation formation column 1 may have a larger diameter if desired.

The system for recovering of FIG. 1 may include a wash station 200. Baskets 5 containing recovered precipitate are transported to wash station 200, and positioned above a wash tank 7. An aqueous wash solution is circulated by pump 8 from wash tank 7 to an outlet above the basket 5. The wash solution then flows through basket 5, washing the precipitate.

The boundaries of the recovery station 100 are defined by barriers 12 and 13. The boundaries of the wash station 200 are defined by barriers 13 and 14. As discussed below, baskets 5 may be suspended above catch tank 6 and/or wash tank 7 using rails or cables 15.

In various embodiments, the system for recovering uranium may include a drying station 300. Baskets 5 containing washed precipitate are transported to drying station 300, and suspended from hooks or loops 9 on a drying rack 10. The drying rack suspends the baskets above a drip pan 11.

Once the precipitate in the baskets is dry, the baskets 5 with the dried precipitate therein are transported to a furnace.

As shown in FIG. 2, baskets 5 include a porous material 23 formed of a material which is stable at a temperature of 500° C. to 800° C. Suitable materials include metals and alloys such as stainless steel, titanium, molybdenum, titanium-zirconium-molybdenum alloys, nickel, tantalum, tungsten, nickel, nickel-chromium alloys, and alloys thereof. Porous material 23 may be a mesh of wires formed from a metal or metal alloy. In various embodiments, porous material 23 may be a perforated metal sheet formed from a metal or metal alloy. Porous material 23 may be a fabric or mesh formed from carbon fibers, ceramic fibers, or threads formed from such fibers.

Baskets 5 include a non-porous material 22 formed of a metal which is stable at a temperature of 500° C. to 800° C., such as stainless steel, titanium, molybdenum, titanium-zirconium-molybdenum alloys, nickel, tantalum, tungsten, nickel, nickel-chromium alloys, and alloys thereof. Non-porous material 22 adds rigidity to basket 5.

Baskets 5 may include a top 21 with hooks or flanges 21a. Hooks or flanges 21a may be configured to suspend baskets 5 above catch tank 6 and wash tank 7, by catching rails or cables 15 above tanks 6 and 7. Hooks or flanges 21a may also be configured to suspend baskets 5 above drip pan 11, by catching hooks or loops 9 on drying rack 10.

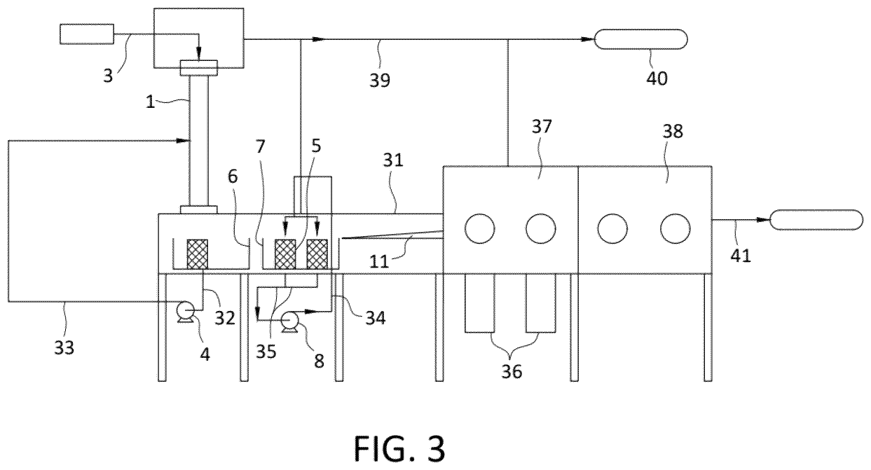

FIG. 3 shows a second embodiment of a system for recovery of uranium from a uranyl nitrate solution. Acid deficient uranyl nitrate flows from input 3 to formation column 1, which may be a glass or metal tube which is bolted to a uranyl nitrate recovery enclosure 31. A basket 5 is positioned within or above the catch tank 6. Pump 4 pumps a base solution, e.g., ammonium hydroxide solution, from the catch tank 6 through conduit 32 to the formation column 1 through conduit 33. While pump 4 operates, a consistent volume of the base solution is maintained within formation column 1. The acid deficient uranyl nitrate is added dropwise from input 3 to formation column 1. The uranyl nitrate reacts with the base to produce insoluble diuranate salts which, together with the recirculating ammonium hydroxide solution, flow out of a nozzle (shown in FIG. 1) at the bottom of column 1. The insoluble diuranate salts are captured in basket 5, and the ammonium hydroxide solution flows into catch tank 6 and is then pumped back to formation column 1.

The baskets 5 are then transferred to a position in or above wash tank 7. A wash solution is pumped by pump 8 through conduit 34 to outlets above baskets 5. The wash solution then flows through baskets 5 into wash tank 7. Fluid within wash tank 7 flows through conduit 35 to pump 8 and is recycled back to the wash tank through conduit 34. After washing, the washed baskets 5 and their diuranate salt contents are transferred to a drying station and stored above drip pan 11 until the diuranate salts are dry.

The baskets 5 and their dry diuranate salt contents are transferred to a recovery oxidation furnace 37. The recovery oxidation furnace 37 may be heated in a variety of ways. The recovery oxidation furnace 37 may have walls formed of graphite which may be resistively heated. The recovery oxidation furnace 37 may be heated by electrically conductive coils. The recovery oxidation furnace 37 may be heated by high temperature vertical tube furnaces 36. The vertical tube furnaces 36 may have ceramic heating elements, e.g., molybdenum disilicide (MoSi₂) heating elements, installed therein. The vertical tube furnaces 36 may reach temperatures of up to 1800° C.

The precipitate is oxidized in the oxidation furnace. Where the system is used to recover a transition metal by converting a transition metal nitrate, e.g., iron (III) nitrate, a transition metal oxide salt or a transition metal hydroxide salt, e.g., iron (III) hydroxide, is recovered and heated to produce an oxide, e.g., iron (III) oxide. A similar procedure works with other actinide metal nitrates, lanthanide metal nitrates, and transition metal nitrates. Zirconium oxynitrate, ZrO(NO₃)₂ cerium nitrate Ce(NO₃)₃, and yttrium nitrate Y(NO₃)₃, for example, may be reacted with ammonia or ammonium hydroxide to produce precipitates, which can be converted to oxides by heating using systems according to FIG. 1 and/or FIG. 2.

In cases where the baskets 5 contain ammonium diuranate, the temperature of the recovery oxidation furnace 37 is controlled, based on the final uranium oxide product desired. When ammonium diuranate [(NH₄)₂U₂O₇] is heated to about 420° C. to 550° C., the compound undergoes denitration and conversion to UO₃. When ammonium diuranate is heated to about 550° C. to 850° C., the compound is converted to an oxide with an approximate formula of U₃O₈. However, such conversions occur under ideal circumstances; commonly, the final product may be a mixture or alloy of various uranium oxides, e.g., UO₂, U₂O₅, UO₃, U₃O₈, UO₂O₂, or a mixture thereof. At a temperature of >900° C., or >1000° C., the ammonium diuranate may be converted to an oxide with an approximate formula of U₈O₂₁.

After conversion of ammonium diuranate to an oxide ceramic in recovery oxidation furnace 37, baskets 5 containing uranium oxide ceramics are transferred to glovebox 38 for cooling. Once the baskets 5 have cooled to an acceptable temperature, baskets 5 are recovered via path 41, and the uranium oxide contents are recovered.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of recovering a useful metal from a solution of a nitrate salt of a metal cation or a metal oxycation, comprising:
adding the solution of the nitrate salt to a formation column having an inlet and an outlet nozzle, the solution of the nitrate salt being added in a dropwise fashion through the inlet,
wherein the formation column contains a recirculating solution containing a base selected from the group consisting of ammonia, ammonium hydroxide, an alkali metal hydroxide, and an alkaline earth metal hydroxide;
allowing the nitrate salt in the solution to react with the base in the recirculating solution to produce a metal oxide salt or a metal hydroxide salt as a precipitate;
allowing the precipitate and the recirculating solution to exit the formation column through the outlet nozzle;
capturing the precipitate in a basket beneath the formation column while recovering the recirculating solution in a catch tank under the basket; and
pumping the recovered recirculating solution from the catch tank to the formation column.

2. The method of claim 1, wherein the nitrate salt is a salt of a cation or an oxycation of a main group metal, a transition metal, a lanthanide metal, or an actinide metal.

3. The method of claim 1, wherein the nitrate salt is uranyl nitrate, thorium nitrate, or plutonium nitrate.

4. The method of claim 3, wherein:
the nitrate salt is uranyl nitrate,
the base is ammonia or ammonium hydroxide, and
the precipitate is ammonium diuranate.

5. The method of claim 4, wherein the base is ammonium hydroxide.

6. The method of claim 3, wherein the nitrate salt is uranyl nitrate, the base is the alkali metal hydroxide, and the precipitate is an alkali metal diuranate.

7. The method of claim 1, further comprising:
washing the precipitate with an aqueous wash solution; and
drying the washed precipitate;
wherein the precipitate is kept in the basket during the washing and drying steps.

8. The method of claim 7, further comprising:
transporting the basket containing the captured precipitate from beneath the formation column into an oxidizing furnace,
heating the basket containing the captured precipitate in the oxidizing furnace to convert the precipitate into a metal oxide.

9. The method of claim 8, wherein:
the nitrate salt is uranyl nitrate,
the base is ammonia or ammonium hydroxide,
the precipitate is ammonium diuranate, and
the metal oxide is UO₂, U₂O₅, UO₃, U₃O₈, UO₂O₂, or a mixture thereof.

10. The method of claim 1, wherein the nitrate salt is iron (III) nitrate.

11. The method of claim 10, wherein:
the base is ammonium hydroxide, and
the precipitate is iron (III) hydroxide.

12. The method of claim 1, wherein the nitrate salt is yttrium (III) nitrate or cerium (III) nitrate.

13. The method of claim 12, wherein:
the base is ammonium hydroxide, and
the precipitate is yttrium (III) hydroxide or cerium (III) hydroxide.

14. A method of recovering a useful metal from a solution of a nitrate salt of a metal cation or a metal oxycation using a system comprising a formation column having an inlet and an outlet nozzle, wherein the inlet is configured to admit solution of the the nitrate salt to the formation column in a dropwise fashion; a basket under the outlet nozzle; a catch tank under the basket; and a recirculation system comprising a first pump and a flow path between the catch tank and the formation column, the method comprising:
adding the solution of the nitrate salt to the formation column, the solution of the nitrate salt being added in a dropwise fashion through the inlet, wherein the formation column contains a recirculating solution containing a base;
allowing the nitrate salt in the solution to react with the base in the recirculating solution to produce a metal oxide salt or a metal hydroxide salt as a precipitate;
allowing the precipitate and the recirculating solution to exit the formation column through the outlet nozzle;
capturing the precipitate in the basket while recovering the recirculating solution in the catch tank; and
pumping the recovered recirculating solution from the catch tank to the formation column with the first pump.

15. The method of claim 14, wherein the nitrate salt is a salt of a cation or an oxycation of a main group metal, a transition metal, a lanthanide metal, or an actinide metal.

16. The method of claim 14, wherein the nitrate salt is uranyl nitrate, thorium nitrate, or plutonium nitrate.

17. The method of claim 16, wherein:
the nitrate salt is uranyl nitrate,
the base is ammonia or ammonium hydroxide, and
the precipitate is ammonium diuranate.

18. The method of claim 14, further comprising:
transporting the basket containing the captured precipitate from beneath the formation column into an oxidizing furnace,
heating the basket containing the captured precipitate in the oxidizing furnace to convert the precipitate into a metal oxide.

19. The method of claim 14, wherein the nitrate salt is iron (III) nitrate, yttrium (III) nitrate, or cerium (III) nitrate.

20. The method of claim 14, wherein:
the nitrate salt is iron (III) nitrate and the precipitate is iron (III) hydroxide;
the nitrate salt is yttrium (III) nitrate and the precipitate is yttrium (III) hydroxide;
or
the nitrate salt is cerium (III) nitrate and the precipitate is cerium (III) hydroxide.
